(19) United States
(12) Patent Application Publication
(10) Pub. No.: US 2026/0332644 A1
(43) Pub. Date: Oct. 22, 2026

(54) SYSTEM AND METHOD FOR STATELESS KERNEL-LEVEL SESSION HIJACKING, NEURAL RESPONSE SYNTHESIS DECEPTION, AND AUTONOMOUS HARDWARE CONTAINMENT IN CONVERGED NETWORKS

(71) Applicant: Tristan Kayden Everhart, Haymarket, VA (US)

(72) Inventor: Tristan Kayden Everhart, Haymarket, VA (US)

(21) Appl. No.: 19/679,661

(22) Filed: May 16, 2026

(51) Int. Cl. H04L 9/40; H04L 45/00

(52) U.S. Cl. CPC H04L 63/1491; H04L 45/22

(57) ABSTRACT

A system, method, and non-transitory computer-readable medium provide active threat deception and autonomous containment across converged network nodes. The system utilizes a kernel-space interception fabric to hook transport layer protocol channels programmatically via user-space netfilter queues. When a session breaks defined network parameters, a stateless architecture engine drops the incoming packet to remove the target physical device from the wire, while preserving connection continuity statelessly via a bitwise Reverse Header Inversion routine. Intercepted session traffic is asynchronously encapsulated inside isolated multi-tenant overlay tunnels and routed to a neural deception plane. The neural deception plane runs a Generative Adversarial Network (GAN) to dynamically synthesize interactive, context-aware protocol responses based on a calculated geometric threat drift distance. Simultaneously, an autonomous orchestration loop triggers direct, out-of-band infrastructure API calls to enforce boundary firewall blocks and radio-layer wireless client disassociation in under 100 milliseconds, permanently blocking lateral threat progression.

### CROSS-REFERENCE TO RELATED APPLICATIONS

This application claims priority to U.S. Provisional Patent Application No. 64/066,858, filed May 15, 2026, entitled “Generative Adversarial Network (GAN) Driven Autonomous Deception Plane for Dynamic Zero Trust Policy Enforcement”; and U.S. Provisional Patent Application No. 64/067,400, filed May 16, 2026, entitled “System and Method for Stateless Hardware-Level and Logical-Gateway Session Hijacking and Asynchronous Multi-Tenant Encapsulation for the Project Ghost™ Enterprise IT/OT/IoT Converged and Wireless Network Deception Enforcement Plane.” This application further relates to, and integrates the governance frameworks of, U.S. Provisional Patent Application No. 64/067,939, filed May 17, 2026, entitled “Autonomous Compliance Orchestration Broker.” The entire disclosures of all three tracking applications are incorporated by reference herein for all purposes.

### BACKGROUND OF THE INVENTION

### 1. Field of the Invention

The present invention relates generally to computerized network security, and more specifically to a stateless kernel-level data-plane session hijacking framework integrating machine-learning-driven real-time multi-tenant protocol emulation, spatial threat drift analytics, and autonomous hardware-layer isolation loops across converged Information Technology (IT), Operational Technology (OT), Industrial Control Systems (ICS), and Internet of Medical Things (IoMT) systems.

### 2. Description of the Related Art

Modern converged enterprise networks suffer from a fatal security flaw: parameter-driven lateral vulnerability. Traditional inline security boundaries, firewalls, and Network Access Control (NAC) models function via perimeter or edge inspection. Once an advanced threat actor or automated software exploit achieves an initial ingress foothold through compromised credentials or unpatched vulnerabilities, the east-west lateral logical paths within the internal network architecture remain exposed. This allows the attacker to execute reconnaissance, scan for high-value targets, and exfiltrate data.

Furthermore, legacy active threat containment models typically isolate compromised assets via endpoint agents or by triggering abrupt network topology changes (e.g., VLAN steering, 802.1X link state flaps, or TCP resets). These methods create distinct network anomalies and interface signature leakages that let sophisticated attackers know they have been detected, prompting them to change tactics. Additionally, human-managed security operations center (SOC) validation loops introduce significant latency (ranging from minutes to hours), allowing rapid, machine-speed automated scripts to fulfill malicious payloads before remediation occurs. Accordingly, there is an urgent need for an invisible, inline, kernel-space session manipulation and adaptive containment infrastructure that traps threats without signature leakage or execution latency.

### SUMMARY OF THE INVENTION

The present invention addresses these flaws by introducing an inclusive, sub-operating system (sub-OS) cyber-deception and autonomous mitigation fabric. The system combines a Stateless Architecture Engine (SAN Engine) operating natively inside kernel-level table space with a Generative Adversarial Network Dynamic Synthesis Loop (The GAN Engine) to achieve absolute network invisibility, real-time threat containment, and zero-footprint session handover.

When an anomaly breaks defined network parameters, the SAN Engine programmatically extracts the raw packet descriptor from the standard host routing matrix using Netfilter Queue hooks, causing the target physical device to disappear from the wire. Simultaneously, the engine maintains connection continuity statelessly via a bitwise Reverse Header Inversion routine that clones sequence metrics mid-stream. The intercepted session is asynchronously wrapped inside isolated multi-tenant overlay tunnels (e.g., VXLAN VNIs or GRE encapsulations) and handed over to the GAN Engine, which generates highly interactive, context-aware protocol responses (such as Modbus, DICOM, or MQTT) on the fly based on threat drift matrices. Concurrently, an autonomous containment loop bypasses human management chains to update perimeter network switch firewalls and force radio-layer client disassociation across Wireless LAN Controllers (WLCs) in under 100 milliseconds, permanently neutralizing lateral threat progression.

### BRIEF DESCRIPTION OF THE DRAWINGS

FIG. 1 is a structural block and topological diagram illustrating the inline kernel-space interception, packet manipulation, and traffic mutation routing pathways within the converged network architecture, according to one embodiment of the present invention.

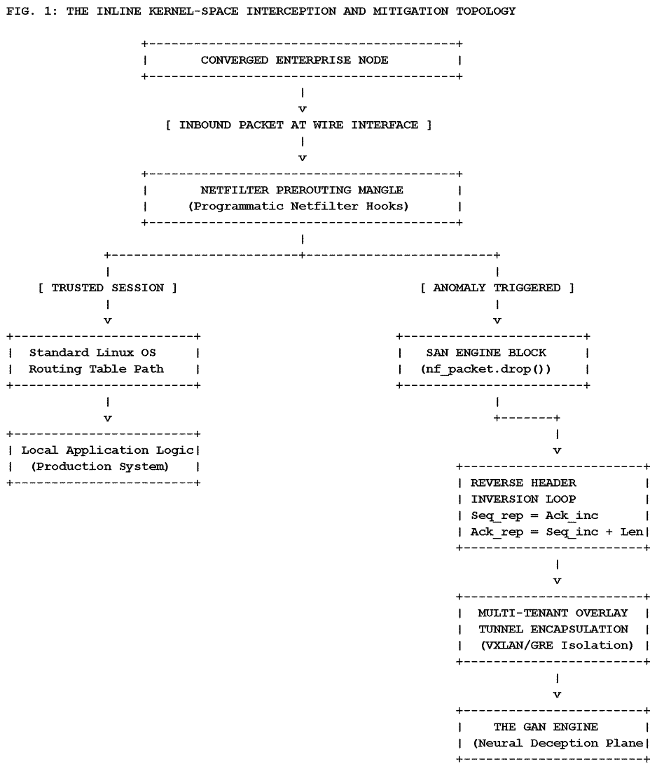

FIG. 2 is a functional block diagram and flow schematic illustrating the neural deception lifecycle, including the asymmetric geometric distance calculation, adaptive entropy mutation scaling, and context-aware protocol emulation loops, according to one embodiment of the present invention.

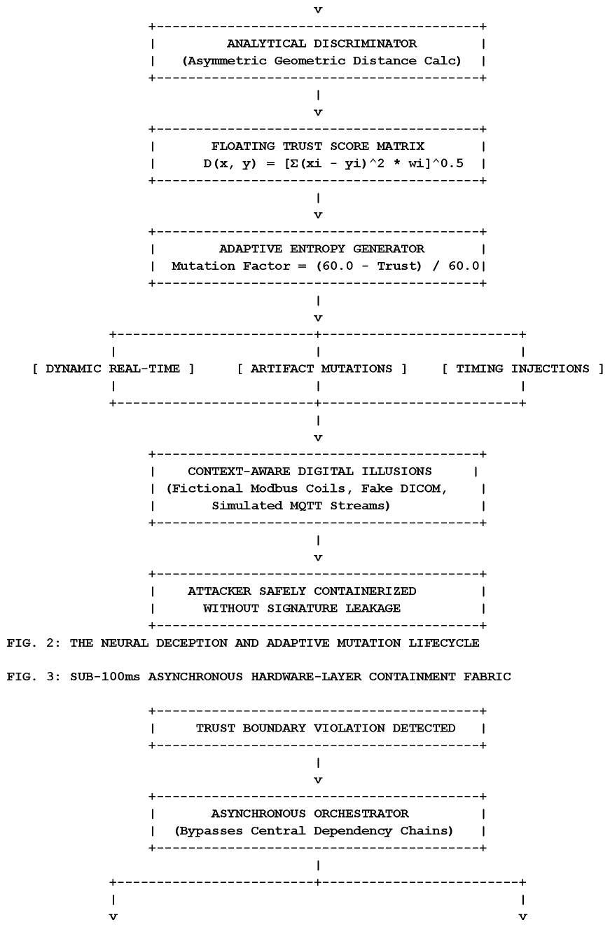

FIG. 3 is a structural routing and system component flow diagram illustrating the sub-100-millisecond asynchronous out-of-band hardware-layer containment fabric and parallel isolation execution paths, according to one embodiment of the present invention.

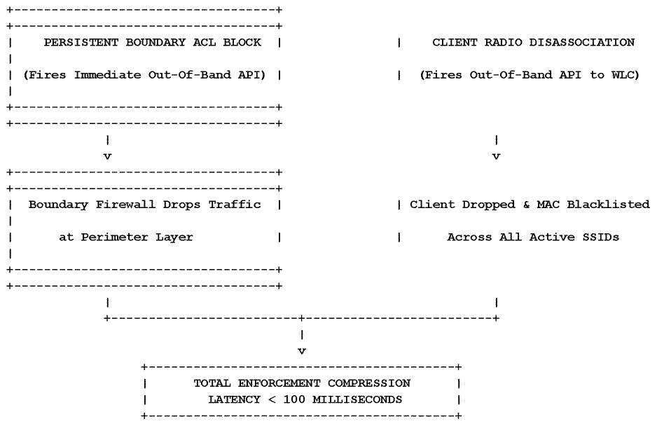

### DETAILED DESCRIPTION OF THE PREFERRED EMBODIMENTS

Referring to the architectural models and engineering specifications, the present invention consists of three integrated, co-dependent planes operating across converged enterprise network nodes:

### 1. The SAN Engine and Kernel-Level Interception Architecture

The Policy Enforcement Point (PEP) is implemented directly within the kernel-space table layer using programmatic Netfilter queue hooks. As packets arrive at the network interface, mangle hooks evaluate transport layer attributes before standard operating system routing tables process the frame. If an anomaly threshold is broken, the engine issues a packet dropping command (nf_packet.drop( )) to remove the production hardware asset from the threat trajectory.

To maintain connection state without consuming memory state blocks (which would introduce vulnerability to State-Exhaustion DDOS attacks), the SAN Engine maps a synthetic reply header statelessly via Reverse Header Inversion, governed by the following mathematical constraints:
Seq_reply=Ack_incoming Ack_reply=Seq_incoming+max(1, Len(Payload_incoming))

### 2. The GAN Engine and Neural Deception Plane

Intercepted sessions are asynchronously encapsulated into multi-tenant overlay network layers, separating malicious payloads from default enterprise virtual routing paths (e.g., wrapping industrial OT sweeps into VXLAN VNI 3040 and medical IoMT sweeps into VXLAN VNI 3030). Control shifts to a specialized Generative Adversarial Network (GAN) trained on passively aggregated network metadata baselines.

The Analytical Discriminator measures threat drift using an asymmetric geometric distance calculation to produce a floating Trust Score:

D(x, y)=[(xi−yi)\hat{ }2*wi]\hat{ }0.5

The Adaptive Entropy Generator evaluates this Trust Score to scale a precise Mutation Factor:
Mutation Factor=Max(0.0, (60.0−Trust Score)/60.0)

As the score falls, the engine synthesizes completely interactive, context-aware digital illusions (fictional Modbus coils, fake DICOM patient matrices, or simulated MQTT streams) that add artificial micro-latencies and variable register mutations to keep the attacker safely containerized inside the simulation.

### 3. Autonomous Hardware-Layer Isolation

At the Exact Microsecond an Anomaly breaks trust boundaries, an asynchronous orchestrator bypasses external software dependency chains to fire immediate out-of-band containment APIs to edge networks: (a) applying persistent boundary firewall drop access control rules, and (b) executing client radio-layer disassociation and MAC blacklisting across all corporate Wireless LAN Controller (WLC) SSIDs. This compresses total containment latency to under 100 milliseconds.

What is claimed is:

1. A system for active threat deception and autonomous containment across converged network nodes, comprising a memory layer allocated within a non-swappable kernel-space memory block; a kernel interception fabric operating inside a network data plane configured to bind transport layer protocol ports programmatically to a user-space netfilter queue; a stateless architecture engine running on a processor, configured to evaluate header metrics of incoming packets against a telemetry baseline matrix, execute a packet dropping directive to remove a physical destination asset from a routing directory if an anomaly threshold is broken, and generate a synthetic response packet statelessly via a reverse header inversion loop; and a neural deception plane running a generative adversarial network, configured to asynchronously encapsulate intercepted packet traffic inside an isolated multi-tenant overlay network tunnel and generate context-aware simulated protocol responses dynamically on said overlay tunnel based on calculated geometric threat drift values.

2. The system of claim 1, wherein said reverse header inversion loop calculates a stateless response sequence value by directly matching an incoming packet's acknowledgment value, and calculates a stateless response acknowledgment value by summing an incoming packet's sequence value with a calculated transport segment payload length variable.

3. The system of claim 1, wherein said neural deception plane incorporates an analytical discriminator configured to run an asymmetric geometric distance calculation measuring spatial feature variations between active packet stream attributes and said telemetry baseline matrix to derive a floating trust score.

4. The system of claim 3, wherein said neural deception plane incorporates an adaptive entropy generator configured to derive an active mutation factor from said trust score, wherein said mutation factor dictates real-time fuzzing, timing jitter injection, and protocol field mutations applied to the synthesized protocol responses.

5. The system of claim 1, further comprising an autonomous containment engine configured to bypass central system orchestration layers upon trust boundary violation and execute a sub-100 millisecond out-of-band hardware isolation routine.

6. The system of claim 5, wherein said out-of-band hardware isolation routine automatically transmits a persistent drop access control list rule to boundary firewalls and triggers an immediate client radio-layer disassociation and hardware MAC-address blacklist across all active Wireless LAN Controller service set identifiers simultaneously.

7. A method for active threat deception and autonomous containment across converged network nodes, comprising: hooking incoming packet streams inline at a kernel routing sub-layer via a user-space netfilter queue handler before the packet stream hits local application logic; evaluating packet descriptors against a passively generated network telemetry baseline matrix; executing an inline packet drop directive to extract an anomalous session from a standard host routing table, rendering a target physical device profile invisible on the network wire; inheriting said anomalous session statelessly by generating a synthetic reply frame via reverse header inversion where an outgoing sequence metric is matched directly to an incoming acknowledgment value; wrapping intercepted packets into an isolated multi-tenant overlay network layer separated from production virtual routing instances; and synthesizing interactive, context-aware protocol responses dynamically on said overlay network layer using a generative adversarial network configured to adjust response entropy based on real-time geometric threat drift distances.

8. The method of claim 7, further comprising executing an autonomous containment loop at the microsecond of trust boundary violation by transmitting direct API isolation instructions out-of-band to network edge appliances, wherein boundary firewalls apply a persistent drop rule and wireless controllers execute hardware MAC blacklisting across all active wireless networks in under 100 milliseconds.

9. A non-transitory computer-readable medium storing instructions that, when executed by a processor, cause the processor to perform network threat containment by: monitoring transport layer protocol parameters at a kernel netfilter prerouting mangle junction; transferring an anomalous packet descriptor to a user-space handling daemon via an asynchronous netlink socket queue; dropping the anomalous packet from the host operating system routing path to mask a target destination asset; cloning transport layer connection states statelessly by mapping an inverse sequence-acknowledgment header profile back to a source device; routing subsequent session traffic into an encapsulated multi-tenant VXLAN or GRE tunnel layer; and
generating fuzzed, changing protocol responses dynamically inside said tunnel layer by processing session attributes through a neural network model configured to scale response mutation based on calculated spatial drift distance values.
